(19) United States
(12) Patent Application Publication
(10) Pub. No.: US 2014/0337109 A1
(43) Pub. Date: Nov. 13, 2014

(54) System and method for co-ordering

(71) Applicant: Serge Sokolov, Godalming (GB)

(72) Inventor: Serge Sokolov, Godalming (GB)

(21) Appl. No.: 14/275,877

(22) Filed: May 12, 2014

(30) Foreign Application Priority Data
May 13, 2013 (GB) 1308578.2
Sep. 16, 2013 (GB) 1316429.8

(51) Int. Cl. G06Q 30/06

(52) U.S. Cl. CPC G06Q 30/0605; G06Q 30/0635
USPC 705/12; 705/26.2

(57) ABSTRACT

A system and a method for facilitating joint orders (“co-orders”) from one or more associated customers and non-customers to one or more vendors via computer networks. The system includes one or more customer subsystems, one or more vendor subsystems, at least one coordination subsystem, zero or more social network subsystems, connected to computer networks. One user fixes one or more parameters of a co-order, sends zero or more invitations to other users to join in forming the co-order, which they can accept. Information about the co-order is synchronized between participating user devices. Once users have agreed on particulars of the co-order, it is placed with one or more vendors. Users may be customers and non-customers thus allowing participation of experts, friends, etc.

### CROSS REFERENCE TO RELATED APPLICATIONS

This application is based on, and claims priority to UK Patent Application No. 1316429.8, filed on Sep. 16, 2013, and UK Patent Application No. 1308578.2, filed May 13, 2013, the contents of all two applications are hereby incorporated by reference in their entirety for all purposes.

### BACKGROUND

Disclosed invention relates to technology employed in offering and ordering of goods and services, especially when multiple parties are involved in forming and placing an order, and also using social networks to provide enhanced user experience.

Online and mobile shopping is rapidly becoming preferred way of purchasing goods, groceries, services, etc. Similar e-commerce technology which allows ordering and/or checking out goods using specialized or customer's own devices is also employed by local businesses such as restaurants, pubs, cafes, shops, etc.

Most prior art electronic shopping systems require a single customer (a person or an organization) to be the holder of a customer account with them in order to be able to form and place an electronic order. This may pose a multitude of issues when multiple parties wish to choose and/or receive goods and/or services together. Amongst such issues are: additional time and burden required to coordinate choices between ordering parties, increased risk of making a mistake in an order, obstructed access to the order information by parties, etc.

### SUMMARY

The present invention recognizes and addresses the issues arising when multiple parties are involved in forming and placing one or more electronic orders with one or more vendors.

Among its several aspects, the present invention provides system and method which facilitate co-ordering by one or more associated parties (users) from one or more user devices. The method includes the steps which allow users to create, share and collaboratively form one or more co-orders, which are then placed with one of more vendors when agreement between participating parties is reached.

It is contemplated by the inventor, that disclosed invention could be utilized to extend functionality of many existing vending systems and devices by those skilled in art without significant modification of such systems, this way making them useful for co-ordering when it was not originally envisaged by their respective creators.

The accompanying drawings, which are incorporated in and constitute a part of this specification, illustrate one or more embodiments of the present invention.

### BRIEF DESCRIPTION OF THE DRAWINGS

The accompanying drawings are not intended to be drawn to scale. For purposes of clarity, not every component may be labeled in every drawing. In the drawings:

FIG. 1 is a flow diagram of a method of co-ordering according to some embodiments;

FIG. 2 shows a block diagram of the co-ordering system according to some embodiments;

FIG. 3 shows a block diagram of a user device according to some embodiments.

### DETAILED DESCRIPTION

It should be noted that terms “customer”, “co-order”, “order”, “vendor” are only used to describe a subset of all possible embodiments of the present invention, and not to limit the scope of the invention. Those skilled in art would appreciate how present invention could be adopted for other purposes, at the moment or in the future, without departing from its spirit.

It should also be appreciated that in certain scenarios, present invention allows single customer to place single order to single vendor without losing additional benefits described herein and not found in prior art, however for the purpose of fluency of description the plural forms of terms “customers” and “orders” will be mostly used forthwith.

Components of the system described herein can be implemented by those skilled in art in hardware, software, combination thereof, on a single physical device or on multiple connected devices, as they will be able to determine depending on particular circumstances. Any described component could be implemented by those skilled in art as two or more interconnected sub-components which communicate with each other accordingly to provide envisaged functionality without departing from the spirit of this invention. By way of example, one given component could be split into two sub-components residing on two connected physical devices using available technologies and well known design techniques such as client-server, peer-to-peer, etc.

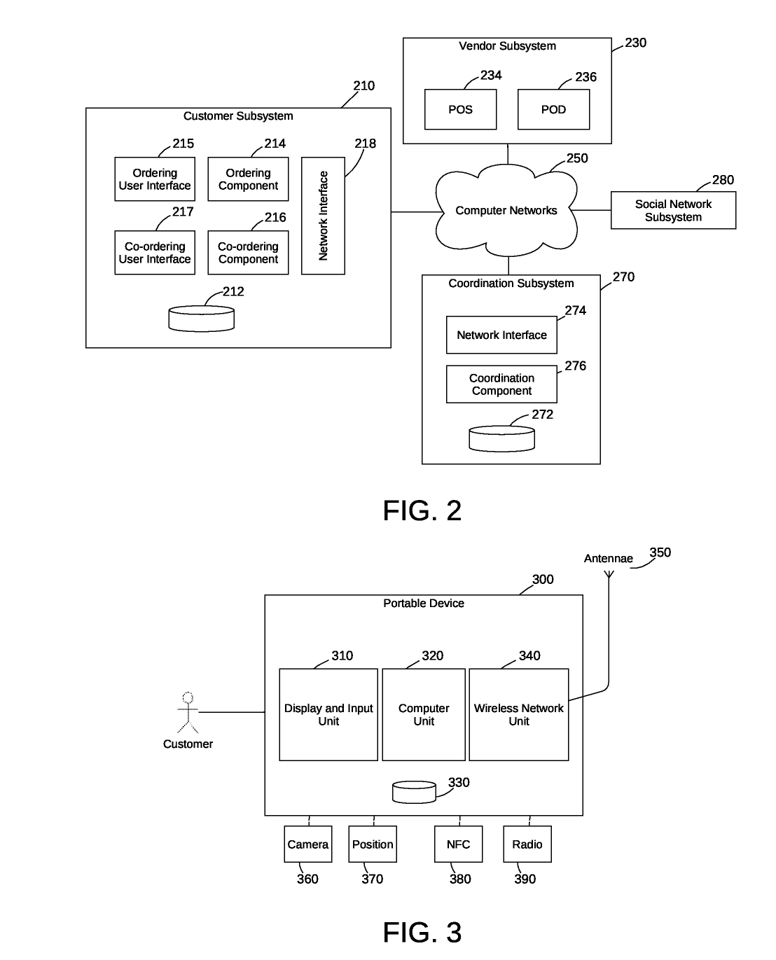

In reference to FIG. 2, the co-ordering system includes one or more customer subsystems 210, one or more vendor subsystems 230, at least one coordination subsystem 270, zero or more social network subsystems 280, connected to computer networks 250. Customer subsystems 210 include ordering component 214 with ordering user interface component 215, co-ordering component 216 with co-ordering user interface component 217.

Customer subsystems 210 can be implemented on a range of physical devices, stationary or portable, with at least two interfaces: a human user interface and a computer network interface. Examples of such devices include iPhone, iPad, iPod (by Apple Corporation, CA), running iOS Operating System, range of devices manufactured by various vendors running Android Operating System (by Google Corporation, CA et al), as well as PCs, Laptops, etc. of various manufacturers, as well as any specialized vending machines which are capable of embedding co-ordering related components 216, 217 or parts thereof.

In a preferred embodiment, one of the implementations of the customer subsystem 210 is performed on a portable user device such as mobile phone or a tablet 300, which includes at least the following units: display with touch sensors 310, application computer unit 320 with volatile and long-term memory modules 330, wireless network unit 340 with antennae 350. Additionally, the device 300 can be equipped with any combination of the following peripherals: Camera module 360, Location module (such as GPS) 370, Near Field Communication module 380, Mobile radio network module 390.

In such implementation, the user interfaces 215, 217 are provided via touch display 310 and network interface 218 is provided by wireless network unit 340 with support of computer unit 320 and memory 330. Software components executed by the computer unit 320 are stored in memory 330 accessible by the computer unit. Such components include: Operating System (OS) and optionally a Browser component supplied by the vendor of the device or a third party, one or more applications which implement ordering and co-ordering components 214, 216.

In a preferred embodiment, such applications are built using Web standards (as specified by World Wide Web Consortium) by applying relevant practices of the industry, with the benefit of that these could be used on a wide range of consumer devices without having to be redeveloped for each model of consumer devices.

In some embodiments, such applications are built as what industry calls “native applications” by those skilled in art using specialized software development kits provided by respective vendors of such devices, or by third parties, as a person skilled in art will be able to determine. Examples of such development kits are iOS SDK v6.0 and higher (Apple Corporation, CA) and Android SDK v3.2 and higher (Google Corporation, CA).

In some embodiments where customer subsystem uses a third-party ordering component 214 and such component provides integration facilities which allow managing orders, the co-ordering component 216 is implemented by those skilled in art to interact with the said ordering component using its integration facilities to support the functionality described herein.

In some embodiments where customer subsystem uses a third-party user interface 215 and such interface provides integration facilities which allows integration with or into another user interface, the co-ordering user interface 217 is implemented by those skilled in art to interact with the said ordering user interface using its integration facilities.

In the present invention, coordination subsystem 270 includes coordination component 276 with a database 272 storing information about co-orders and customers. The co-ordering component 216 communicates with the coordination component 276 over generally one or more computer networks 250. As understood in art, such computer networks may include local area networks (LAN), wide area networks (WAN), ad-hoc and peer-to-peer networks, etc. utilizing any appropriate data transmission paths and data encodings in order to achieve communication between components described herein.

In an exemplary embodiment, coordination subsystem 270 is implemented as one or more servers with network interface 274 running Server applications. Server applications are implemented by those skilled in art using server-side programming technologies such as Java (by Oracle Corporation, CA), Microsoft.NET (Microsoft Corporation, WA) and/or others, as well as database systems by the above mentioned or third-party suppliers. The co-ordering component 216 communicates with the coordination component 276 using HTTPS protocol. Authentication of customers and authorization of incoming requests is handled using relevant permission system and implemented by those skilled in art utilizing specifications OAuth 2.0, RFC 6749, RFC 6750. As those skilled in art would appreciate, any other appropriate technologies and specifications may be used instead and/or on top of the mentioned above in implementation of the envisaged functionality described herein.

In the present invention, vendor subsystems 230 include components used by particular vendor to receive and process co-orders and orders. Such components may include zero or more POS (Point of Sale) 234 and zero or more POD (Point of Delivery) 236, as well as web sites, mobile apps, databases, e-mail, etc.

In an exemplary embodiment, information about customers' orders is communicated to existing vendor subsystems 230 (such as Magento eCommerce platform by Ebay Inc., CA) by their respective ordering components 214 when a co-order is placed. In such a way, no modification of the existing vendor subsystem is required in order to support co-ordering. Additionally, when particular vendor subsystem supports this, the information about co-orders can be communicated by coordination component 276 using publish-subscribe mechanism of a message broker such as IBM WebSphere MQ (IBM Corporation, NY), HTTPS POST or any other relevant API as those skilled in art will be able to design and implement.

Social network subsystems 280, to the extent present invention is concerned, include at least one database storing information about connections between users (so called “social graph”). Examples of social network subsystems include Facebook (Facebook Corporation, CA) and Google+ (Google Corporation, CA), which are connected to the WAN and provide appropriate interfaces for accessing information about user and user's social graph as utilized in the exemplary embodiment.

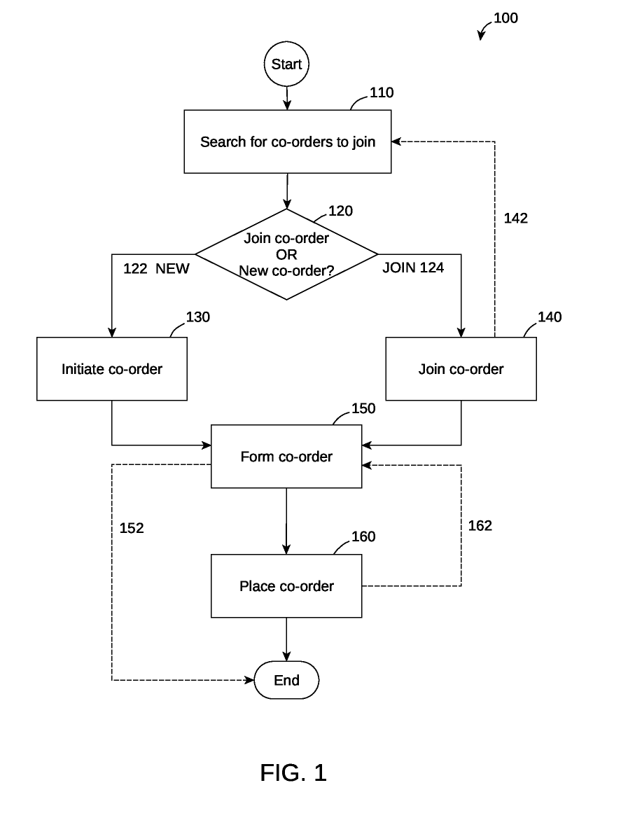

With reference to FIG. 1, in a typical use scenario 100, when a user accesses the co-ordering user interface 217, the co-ordering component 216 performs a search for co-orders that this user may be able to join 110 and the ordering component 214 determines the list of relevant menu items. The menu items may represent products, services, offers, etc., in which case user actions on such items could entail appropriate order items added to an existing or a new order, or may play other functions such as navigation, assigning certain data to certain parameters, etc. according to the vending logic. The user then proceeds to choose an item from either of these lists.

The aforementioned lists could be represented in the user interface in any form depending on type of the device and user preferences, for example categorized or not, searchable or not, with expandable descriptions and hyperlinks or without, etc., so long as the user can act on at least one item from the list if it is not empty. Those skilled in art would be able to determine suitable representations for implementation basing on the capabilities and limitations of the hardware and software platforms their implementation is targeted to.

The menu items are determined by the ordering component 214 depending on data available at the time, and may be revised over time, for example if new data becomes available or a certain period of time lapses. Ordering component 214 uses one or more methods to obtain data, and in case when available data is sufficient to single out one relevant vendor, the component may determine that only products from this vendor should be relevant menu items, in other cases the list of menu items may be compiled from a combination of products from different vendors and/or additional user interface may be provided to narrow the list of vendors down to one vendor. Such data includes data retrieved from memory 212, data previously received from the user and/or device peripherals, data received over network, as well as any data derived from all the above, according to the vending logic.

The list of co-orders that the user is able to join is determined by the co-ordering component 216 from periodically updated data about co-order invitations issued by other users. In an exemplary embodiment such data about co-order invitations are delivered via computer networks 250 from coordination component 276 and social networks 280, as well as received with other means available on a given range of devices 300: over NFC or other short-range transmission technologies from another device 380, in SMS delivered via GSM/UMTS/etc. cellular networks 390, in a email, instant message, push message delivered via computer networks, in a QR-code (ISO/IEC 18004:2000, ISO/IEC 18004:2006) scanned with camera 360, etc. In a preferred embodiment, co-order invitation can be formatted as a hyperlink as well as a QR-code and both are displayed to one user 310. Another user may enter such hyperlink in her browser or scan the QR-code using camera 360 on her phone in order to receive the invitation. In another embodiment, a locally placed tag is programmed via short-range data transmission technology such as Bluetooth with the co-order invitation data by one user's device and subsequently read by one or more user devices.

Furthermore, the information about co-order invitations can also be formatted as a JSON object, XML or any other machine readable code, and could be transmitted using any appropriate communication technologies available now or in the future, as those skilled in art will be able to determine.

In a preferred embodiment, location data is used by the ordering component 214 when determining relevance of menu items related to local businesses such as restaurants, retail shops, etc, as well as by co-ordering component 216 when determining relevance of co-orders and when initiating a new co-order. Location data is obtained from device's 300 navigation system unit such as GPS receiver 370 if available, from locally placed tag such as a QR-code scanned by the user with a camera 360, from a NFC tag read with the NFC reader 380, and/or using other available means. Location data received using tags and/or short-range transmission technologies may, apart from information about the vendor (such as vendor identifier), include information about logical position within a venue of the vendor (such as table or area identifier).

Depending on user's action 120, a new co-order could be started 122 or an existing co-order attempted to be joined 124. Such action could be explicit choice in the user interface 217, call from an external component to the co-ordination component 216 (such as a web browser opening a hyperlink), or an implicit action such as setting one or more order parameters (such as delivery location, time, etc.), or adding at least one order item.

In an exemplary embodiment, information about a co-order is stored in a database of the coordination subsystem 272 and includes: unique co-order identifier, a set of order parameters, a set of order items each with associated order item data and variables, and a set of order variables. Order parameters include set of identifiers of users participating in the co-order, privacy level, counterpart (vendor), delivery information and other parameters and conditions applicable to the type of a business transaction such order would normally represent. Order item data include information about chosen product and its quantity, any required customizations, etc. Additionally, such data include information about one or more users who requested it and for whom this item is for. Order variables and order item variables include co-order version, information about current state of the co-order and the order item respectively. It should be appreciated that all information of a co-order may change during the lifetime of the co-order, depending and according to some predefined rules. Those skilled in art would be able to determine appropriate implementation details for such rules (for example, employing a rule engine component, a state machine, implementing in code etc.)

When a new co-order is initiated 130, certain order parameters such as unique co-order identifier, user identifier, vendor identifier, location and time are assigned appropriate values if such values are known at this stage.

In an exemplary embodiment, vendor identifier and/or location may be obtained from a previously formatted hyperlink which was opened by the user, from a menu item which was chosen by the user or from other information about the vendor and/or location as was determined by the co-ordering component 214 at preceding steps. At this and at later steps user is offered opportunity to send invitations to other users to join in forming this co-order.

In an exemplary embodiment, such new co-order is also assigned the privacy level parameter which would determine who else is allowed to see this co-order and/or join it. Such privacy levels include: “private” (no one else may see or join), “invite-only” (only named users may see or join), “local” (only users located nearby may see or join), “public” (anyone may see or join), or a “social group” (only members of specified group in a social network may see or join). The user may also indicate that anyone without personal invitation must request and obtain an approval before she is allowed to see co-order details and participate in the co-order. Based on user's choice, the co-ordination component 216 issues zero or more invitations to join the co-order, which are then stored in the database 272, optionally formatted as a hyperlink and optionally posted to social network 280, transmitted via email, instant message, SMS or any other relevant paths.

When a user requests to join a co-order 140, the coordination component 276 notifies one or more other users participating in forming of this co-order. Requests to join a co-order may be granted automatically or with a confirmation from one of the existing users, depending on permission information associated with the co-order. In case when the request to join was not accepted 142, the user is notified and is offered to start a new co-order or choose another co-order to join when available 110. If the request to join is accepted, the user is added to the co-order's set of users and proceeds to form the co-order 150 with others.

While the co-order is formed 150, one or more users of the co-order modify certain co-order information such as some of the order parameters, add or remove some order items and modify some order item data, depending on associated permission information.

When co-order information is changed by one user, it is communicated by coordination component 276 to other users associated with this co-order. A person skilled in art would be able to choose and implement appropriate communication methods and protocols for synchronization of information about co-orders between users (for example, using data poll or push techniques), as well as data model and algorithms necessary to implement a permission system. It must be appreciated that in some embodiments users may be allowed to exchange additional information in relation to the co-order (such as text messages, video and audio signaling data and streams, etc.)—as could be implemented by those skilled in art.

When a user is satisfied with the contents of a co-order, she indicates that she agrees to place the co-order, alternatively, in some embodiments she may also be able to indicate her disagreement. If the a user does not wish to participate in the co-order any longer, she may leave the co-order 152. In an exemplary embodiment when last user leaves the co-order, such co-order is deemed abandoned and discarded.

In a preferred embodiment, every user participating in the co-order must agree to the contents of this co-order or deemed to be in agreement with the co-order's final contents before such a co-order could be placed with the vendor and processed further 160. The user interface contains the information about the co-order including the list of order items (order lines), each with the list of users who disagreed with the line. Additionally, each of the lines contains a button allowing the user to disagree with the line and to withdraw her disagreement. The interface also contains a button allowing the user to express full agreement with the co-order. Upon users' action on any of these buttons, appropriate vote requests are formed by the co-ordering component 216 which are then submitted to the coordination component 276. The coordination component maintains voting list associated with each co-order in a database 272 and notifies other users of this co-order when any information changes.

It should be appreciated that in some embodiments there may exist certain rules for determining when users should be deemed to be in agreement with the co-order's final form without having to perform an action. An example of such embodiment may be one which allows to designate one or more users participating in the co-order as a passive customer (or “non-customer”). Such non-voting yet interested party could be a friend, expert, etc.

When a co-order is ready, depending on capabilities of vendor's subsystem 230 to process co-orders, the order is either placed 160 with the vendor 230 as either single co-order or single vendor order, or multiple vendor orders. The following pseudo-code describes logic used in an exemplary embodiment to determine how given co-order is placed with its associated vendor:

procedure place_coorder(order):

if order.vendor.supports_coorders:

# transmit and place co-order as one native co-order
return place_coorder_natively(order)

else:

customers = set(item.customer for item in order.items)
if len(customers) > 1 and not order.order_on_primary_customer:

# ordering for different customers - split into orders per customer
return place_orders(order_slice(order, customer) for customer in customers)

else:

# ordering for a single customer
return place_order(order)

In case when there is any problem with placing the co-order, it is returned back to the users 162 for revision and resubmission.

Described embodiments are applicable to use in various local establishments that provide goods and/or services, such as a restaurant, pub, cafe, shop, hotel, airport, etc., as well as in online commerce where goods and/or services are delivered physically or electronically, especially where two or more customers may be participating in an order. Embodiments allow participation of non-customers (such as experts, friends, assistants, etc.) to provide input while order is being formed, which can be useful for family shopping or preparation for an event.

The foregoing description of preferred and exemplary embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one skilled in art to utilize the invention in various embodiments and with various modifications as are suited to the particular use contemplated. All such modifications and variations are within the scope of the invention as determined by the related claims when interpreted in accordance with the breadth to which they are fairly, legally, and equitably entitled.

1. A system for facilitating one or more co-orders by one or more customers using one or more ordering devices, comprising:
means for coupling the co-ordering component with an ordering component;
means for interfacing with the customer in the co-ordering component;
means for coupling the co-ordering component with a coordination component;
memory means in the coordination component for storing information about co-orders, which for each individual co-order includes information about participating customers and their associated votes;
means for authorizing access of a customer to information about a co-order in the coordination component responsive to the authentication information transmitted from the co-ordering component;
means for updating the information about the co-order in the memory means of the coordination component responsive to the co-order information transmitted from the co-ordering component at an action of the authorized customer;
means for transmitting the information about the updated co-order to its respective participating customers according to the information stored in the memory means of the coordination component responsive to the update of the information about the said co-order;
means for approving the co-order responsive to an action of the authorized customer;
means for determining whether the co-order should be submitted responsive to the approval of the authorized customer;
means for submitting the co-order to one or more vendors' systems responsive to the approval of the authorized customer.

2. A system of claim 1 further comprising of means for determining the list of relevant vendors based on location of the ordering device.

3. A system of claim 2 wherein location information is determined from locally placed tag and includes vendor identifier and logical position identifier.

4. A system of claim 1 further comprising of means of communicating a co-order invitation from one customer to one or more other customers.

5. A system of claim 1 further comprising of means for submitting the co-order to one or more vendors' systems as one or more orders on behalf of one or more customers.

6. A system of claim 4 further comprising of a social network service and means of inviting one or more customers' social connections to join the co-order.

7. A system of claim 4 wherein invitation is encoded in a form of a hyperlink.

8. A system for placing a co-order, comprising:
an identifier that identifies one version of one pending co-order associated with vendor;
an identifier that identifies one session associated with one customer;
a user interface component for displaying information about pending co-order;
a user interface component, which in response to performance of only a single action, sends a message to the coordination component; the message containing session identifier, co-order version identifier, vote flag signifying either agreement or disagreement to place the co-order;
a coordination component, which upon receipt of a message containing vote information, associates it with a customer and with pending co-order stored in its memory means, updates the voting list of the said co-order with the received vote; in case if voting list indicates all customers associated with the co-order are in agreement to place the co-order, actions placement of the co-order with associated vendor.

9. A system of claim 8 wherein voting mechanism allows for non-voting customers.

10. A method for facilitating a co-order from one or more associated customers using one or more ordering devices, the method comprising the steps of:
providing at an ordering device a user interface which includes a list of zero or more invitations from other customers to join them in forming a co-order with one or more associated parameters;
providing at an ordering device a user interface which includes a list of at least one item available for ordering from one or more vendors that match one or more parameters of the pending co-order;
providing at an ordering device a user interface which includes information about one or more items selected by one or more users included into the pending co-order;
providing at an ordering device a user interface which allows a user to express agreement or disagreement with the contents of the pending co-order;
providing means of placing agreed co-order with a vendor.

11. The method of claim 10 further comprising of providing a user interface which allows starting forming a new co-order and a user interface which allows inviting one or more other customers to join the co-order.

12. The method of claim 11 wherein forming a new co-order is initiated by customer's action on a hyperlink and at least one parameter of this new co-order is automatically assigned dependent on information decoded from this hyperlink.

13. The method of claim 11 wherein at least one parameter of the new co-order is automatically assigned dependent on location of the customer.

14. The method of claim 11 wherein at least one person or a group of people suggested for invitation belong to the customers' social network.

15. The method of claim 11 wherein at least one invitation is transmitted to another customer's device in the vicinity of the first customer's device.

16. The method of claim 11 wherein at least one invitation is encoded in a form of a hyperlink.

17. The method of claim 10 wherein a co-order is split into two or more orders which are then placed with one or more vendors.
